(19) United States
(12) Patent Application Publication
(10) Pub. No.: US 2024/0276622 A1
(43) Pub. Date: Aug. 15, 2024

(54) CONTROLLER FOR AN INDOOR GROW LIGHTING SYSTEM

(71) Applicant: HGCI, Inc., Marysville, OH (US)

(72) Inventors: Austin R. Gaylor, Vancouver, WA (US); Yinlin Li, Vancouver, WA (US); William Wai-Loong Young, Vancouver, WA (US); Dengke Cai, Camas, WA (US)

(21) Appl. No.: 18/569,010

(22) PCT Filed: Jun. 17, 2022
(86) PCT No.: PCT/US2022/034045

§ 371 Date: Dec. 11, 2023

Related U.S. Application Data
(60) Provisional application No. 63/212,611, filed on Jun. 19, 2021.

(51) Int. Cl. H05B 47/18; A01G 9/24; H05B 45/30; H05B 47/105; H05B 47/175; H05B 47/21

(52) U.S. Cl. CPC H05B 47/18; A01G 9/249; H05B 45/30; H05B 47/105; H05B 47/196; H05B 47/22

(57) ABSTRACT

A controller for an indoor grow lighting system is provided and can include a digital communication module and an analog communication module that are each configured to communicate with a plurality of light fixtures. The controller also includes a controller area network communication module that facilitates communication with a plurality of sensors. The controller is configured to conduct different testing procedures on the light fixtures.

### REFERENCE TO RELATED APPLICATIONS

This application claims priority of U.S. provisional patent application Ser. No. 63/212,611, filed Jun. 19, 2021, and hereby incorporates this patent application by reference herein in its entirety.

### TECHNICAL FIELD

The apparatus described below generally relates to a controller for a lighting system. In particular, the controller can be configured to facilitate control of a plurality of Light Emitting Diode (LED) light fixtures.

### BACKGROUND

Indoor grow facilities, such as greenhouses, include LED light fixtures that provide artificial lighting to plants for encouraging growth. These LED light fixtures typically include a plurality of LEDs that are communicatively coupled with a controller that facilitates control of the dimming, or other lighting parameters, of the LED light fixtures.

### BRIEF DESCRIPTION OF THE DRAWINGS

Various embodiments will become better understood with regard to the following description, appended claims and accompanying drawings wherein:

FIG. 1 is a schematic view depicting a lighting system that includes a controller and a plurality of primary light fixtures;

FIG. 2 is a front isometric view depicting the controller of FIG. 1 in association with a bracket;

FIG. 3 is a rear isometric view of the controller and bracket of FIG. 2;

FIG. 4 is a detailed schematic view of the lighting system of FIG. 1;

FIG. 5 is a top plan view of a front panel of the controller of FIG. 1;

FIG. 6 is a top plan view of a display screen and a conductive sheet of the front panel of FIG. 5; and

FIG. 7 is an isometric view of the display screen and the conductive sheet of FIG. 6.

### DETAILED DESCRIPTION

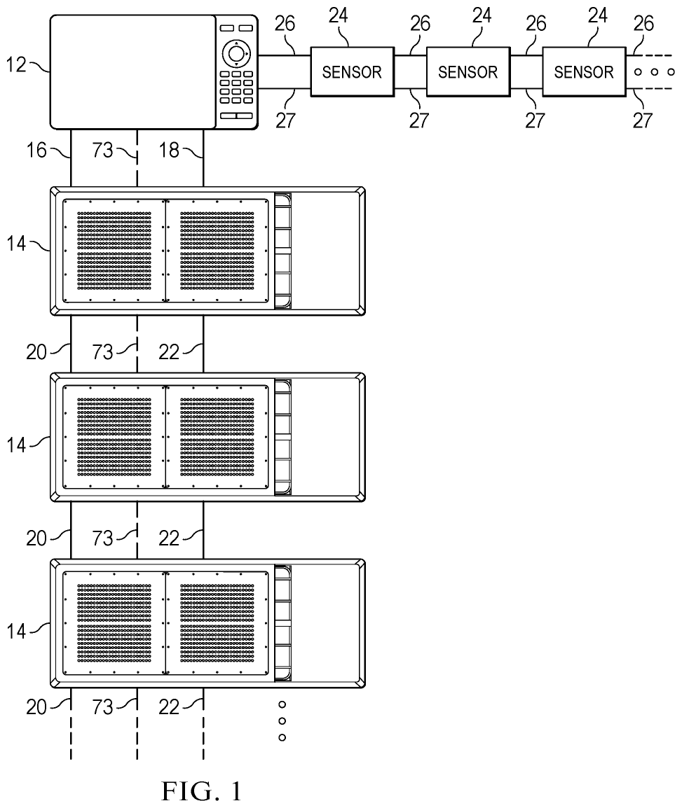

Embodiments are hereinafter described in detail in connection with the views and examples of FIGS. 1-7, wherein like numbers indicate the same or corresponding elements throughout the views. A lighting system 10 for an indoor grow facility (e.g., a greenhouse) is generally depicted in FIG. 1 and is shown to include a controller (e.g., automated greenhouse controller) 12 and a plurality of light fixtures 14 in signal communication with the controller 12. Each of the light fixtures 14 can be arranged within an indoor grow facility and controlled by the controller 12 to generate artificial light for stimulating growth of plants and/or other vegetation provided in the indoor grow facility. The light fixtures 14 can comprise LED-light fixtures, non-LED light fixtures (e.g., HID lights or xenon lights) or some combination thereof.

The controller 12 can be configured to transmit both an analog control signal and a digital control signal that controls the dimming (e.g., lighting intensity) of the light fixtures 14. The controller 12 can be communicatively coupled with a first one of the plurality of light fixtures 14 via an analog communication line 16 and a digital communication line 18. Each of the light fixtures 14 can be communicatively coupled with each other via respective ones of analog communication lines 20 and digital communication lines 22. The analog communication lines 16, 20 can cooperate with each other to form an analog bus that facilitates transmission of the analog control signal from the controller 12 to each of the light fixtures 14. The digital communication lines 18, 22 can cooperate with each other to form a digital bus that facilitates transmission of the digital control signal from the controller 12 to each of the light fixtures 14. It is to be appreciated that although the controller 12 is described as communicating with the light fixtures 14 via both an analog signal and a digital signal (e.g., dual mode communication), in some embodiments, the controller 12 might communicate with the light fixtures 14 with either an analog signal or a digital signal (e.g., single mode communication). The controller 12 can be communicatively coupled with a plurality of sensors 24 via a controller area network (CAN) communication bus 26 and electrically coupled with the sensors 24 via a CAN power bus 27, which will both be described in further detail below.

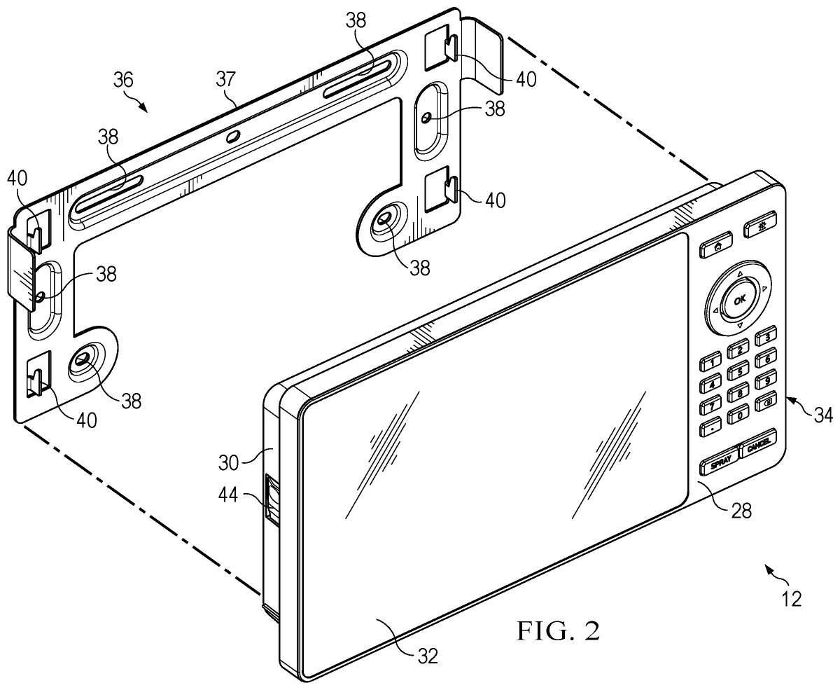

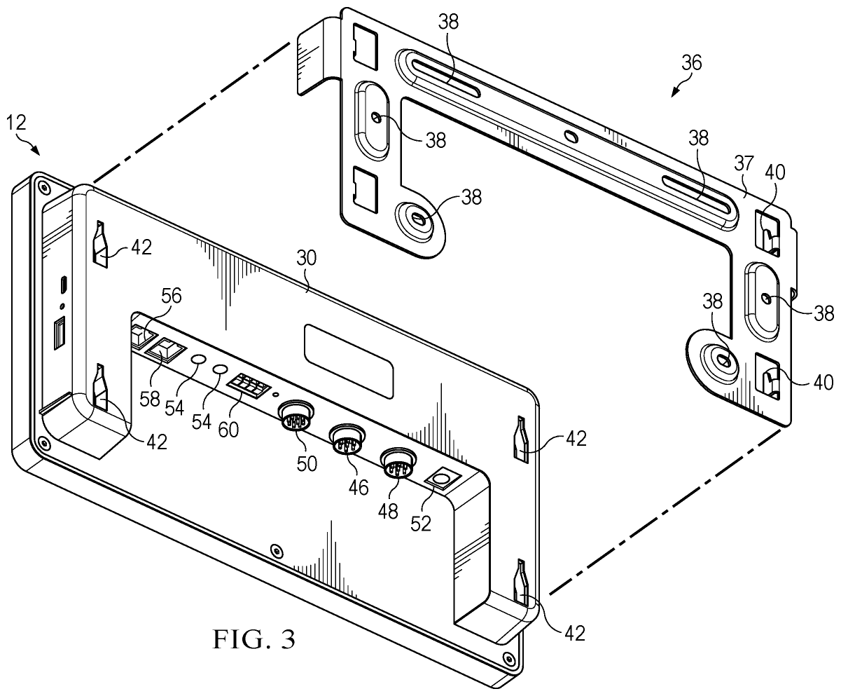

Referring now to FIGS. 2 and 3, the controller 12 is shown to include a front panel 28 and a rear housing 30 that are coupled together. As illustrated in FIG. 1, the front panel 28 can include a display screen 32 and a keypad 34 adjacent to the display screen 32. The display screen 32 can be configured to display a user interface for the light fixtures 14 to a user and can be an LED display, an LCD display, or any of a variety of suitable alternative display formats. A keypad 34 can be configured to allow a user to manually enter information into the controller 12 such as to navigate information on the display and/or to control the light fixtures 14 directly from the keypad 34. In one embodiment, the display screen 32 can comprise a touch screen that allows a user to enter information into the controller 12 by interacting directly with the display screen 32. In some embodiments, the front panel 28 can be devoid of a keypad 34 such that the only way to manually interact with the controller 12 is via the touch screen. The rear housing 30 can be formed of any of a variety of thermally conductive materials, such as thermoplastic, metal (e.g., aluminum or stainless steel), or a composite material (e.g., carbon fiber). In one embodiment, the rear housing 30 can be formed of a carbon fiber reinforced thermoplastic that is impregnated with metal fibers, such as graphene, and can provide enhanced EMF shielding and heat dissipation for the controller 12.

A bracket 36 can be provided that facilitates releasable mounting of the controller 12 to a wall (not shown). The bracket 36 can include a mount plate 37 that defines a plurality of mount holes 38. Fasteners (not shown) can be provided through the mount holes 38 for securing the bracket 36 to the wall. The controller 12 can be releasably mounted to the bracket 36 via a plurality of tabs 40 (FIG. 1) that extend from the mount plate 37. The tabs 40 can extend upwardly and can interface with a plurality of slots 42 defined by the rear housing 30 such that the controller 12 effectively hangs from the tabs 40 to facilitate mounting of the controller 12 to the wall via the bracket 36. The rear housing 30 can be releasably secured to the tabs 40 via a mechanical interface that includes a pushbutton 44 (FIG. 2). To facilitate removal of the controller 12 from the bracket 36 (e.g., to access the back of the controller 12), a user can depress the pushbutton 44 to release the tabs 40 from the rear housing 30 and the controller 12 can be lifted up and away from the bracket 36. This arrangement can allow the controller 12 to be more easily removed from the wall, especially when wearing gloves, than conventional horticultural controllers.

Referring to FIG. 3, the controller 12 can include a first communication port 46 that can accept a cable (not shown) that is plugged into the light fixtures 14 (FIG. 1). The cable can house the analog and digital communication lines 16, 18 illustrated in FIG. 1. In one embodiment, the analog communication line 16 can be a two-wire system (e.g., a positive wire and a negative wire) and the digital communication line 18 can be a two-wire system (e.g., a transmit wire and a receive wire) such that the cable includes at least four wires to accommodate both two-wire systems. The first communication port 46 is shown to be a CNT-13 type connector. However, it is to be appreciated that any of a variety of suitable alternative connection types can be used, such as a Wieland-type connector, an RJ-45 connector, a push-pull connector, or a quick-lock connector. The controller 12 can include a second communication port 48 that allows for a second zone of light fixtures (not shown) to be connected to, and independently controlled by, the controller 12. The controller 12 can control the light fixtures 14 on the second communication port 48 either the same as the light fixtures 14 (e.g., by replicating the control signal of the first communication port 46 onto the second communication port 48) or differently (via different control signals on the first and second communication ports 46, 48) to facilitate independent zone control. The controller 12 can also include a CAN communication port 50 that can be plugged into the sensors 24 via a cable (not shown) to facilitate communication therewith via a CAN protocol.

The controller 12 can also include a power port 52, a pair of probe ports 54, and a first input interface 56. The power port 52 can be configured to be electrically coupled with an external power supply (not shown) that provides input power to the power port 52 for powering the controller 12. In one embodiment, the input power can be about 15 VDC and can be supplied from an external power supply (e.g., an AC/DC power adapter) that is powered from an AC receptacle (e.g., a wall receptacle). The probe ports 54 can be configured for electrical coupling with external sensors that provide external sensor data (e.g., as an analog or digital signal) to the controller 12. The external sensor data can be received by the controller 12 which can control the operation of the light fixtures 14 in response to the external sensor data. In one embodiment, one or more of the external sensors can comprise a temperature probe (not shown), such as, for example, a thermocouple, that is plugged into one of the probe ports 54 and provided at a remote location within a grow facility, such as within a predefined lighting zone. The temperature probe can detect the ambient temperature at the remote location and can transmit the detected temperature to the controller 12 (e.g., as temperature data). The controller 12 can receive the temperature data from the temperature probe and can automatically control the dimming of the light fixtures 14 in the predefined zone to prevent overheating when the ambient temperatures exceed a threshold value.

The first input interface 56 can be configured to be electrically coupled with an external controller (not shown) that can control the operation of the light fixtures 14 independently of the controller 12. When the external controller is coupled with the first input interface 56, the controller 12 can be configured to receive control signals from the external controller and control the light fixtures 14 in response to the instructions requested by the external controller. In one embodiment, the controller 12 can be retrofit into an existing lighting system to enhance the functionality of an existing controller. As such, the controller 12 can be installed between the existing controller and the light fixtures 14 by connecting the existing controller to the first input interface 56 (instead of directly to the lights) and connecting the lights to the first communication port 46. During operation, the existing controller can still control the lights through the controller 12, as described above. The controller 12 can accordingly be easily retrofit into a conventional lighting system to supplement the functionality of an existing controller without requiring replacement of the existing controller, which can be costly and time consuming. In one embodiment, a pair of external controllers (not shown) can be coupled with the controller 12 at the first input interface 56 to allow for independent control of different lighting zones with each of the external controllers. In such an embodiment, each external controller can generate an independent control signal that is provided to either the first communication port 46 or the second communication port 48 to facilitate control the different lighting zones.

Still referring to FIG. 3, the controller 12 can also include second and third input interfaces 58, 60 that are configured to provide access to a plurality of internal contacts (not shown) that are electrically coupled with the second and third input interfaces 58, 60. One set of the contacts can be programmed/mapped (e.g., via the user interface) to change state in response to the light fixtures 14 being turned on or off or based upon an external input (e.g., from the probe ports 54 or the first input interface 56). Another set of the contacts can change state in response to an alarm condition to allow for remote monitoring. The second and third input interfaces 58, 60 can be electrically connected to a remote device (e.g., an external controller) that monitors the status of the light fixtures 14 and/or an alarm condition via the contacts.

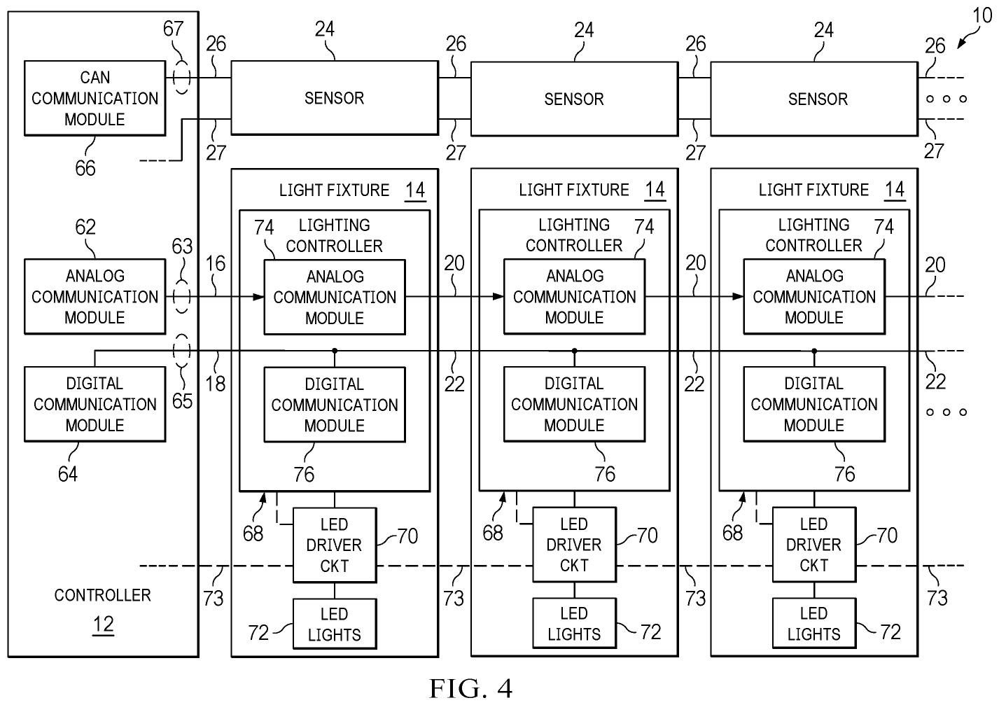

Referring now to FIG. 4, a schematic view of the controller 12 and three of the light fixtures 14 is illustrated and will now be described. The controller 12 can include an analog communication module 62, a digital communication module 64, and a CAN communication module 66. Each of the light fixtures 14 can include a lighting controller 68, an LED driver circuit 70 in communication with the lighting controller 68, and LED lights 72. Each of the light fixtures 14 can be powered by a power bus 73 (shown in dot-dash lines) that is electrically coupled with the controller 12 and receives power therefrom. The power bus 73 can be powered by input power received from the power port 52 or from another power source that is coupled with the controller 12. The power bus 73 can be electrically coupled with each of the LED driver circuits 70 and can facilitate delivery of rated power (e.g., about 3 amps at 15 VDC) from the controller 12 to each of the LED driver circuits 70 for powering of the LED lights 72. The LED driver circuits 70 can be configured to deliver the power from the power bus 73 to the lighting controllers 68 (shown in dot-dash lines) to facilitate powering of the lighting controllers 68 from the power bus 73. In one embodiment, the controller 12 can include an internal transformer (not shown) that can convert the input power received by the controller 12 into the rated power for the light fixtures 14. It is to be appreciated that the light fixtures 14 can additionally or alternatively be powered by an external power source that is routed directly to the light fixtures 14 and thus bypasses the controller 12.

Each of the lighting controllers 68 can include an analog communication module 74 and a digital communication module 76. The analog communication module 62 of the controller 12 can include an analog output 63 that is routed to the first communication port 46 and is communicatively coupled with the analog communication module 74 of a first one of the light fixtures 14 by the analog communication line 16. The analog communication modules 74 of each of the light fixtures 14 can be communicatively coupled together in series via the analog communication lines 20. The digital communication module 64 of the controller 12 can include a digital input/output 65 that is routed to the first communication port 46 and is communicatively coupled with the digital communication module 76 of a first one of the light fixtures 14 by the digital communication line 18. The digital communication modules 76 of each of the light fixtures 14 can be communicatively daisy chained together via the digital communication lines 22. It is to be appreciated that the series connections between the analog communication modules 62, 74 and the daisy chained connections between the digital communication modules 64, 76 can be achieved via internal wiring within the light fixtures 14.

The controller 12 can be configured to simultaneously generate an analog control signal and a digital control signal, via the analog communication module 62 and the digital communication module 64, respectively, that are both capable of controlling the LED lights 72 of the light fixtures 14 to the same lighting intensity. The analog control signal can be transmitted from the analog communication module 62, to the analog output 63, to the analog bus, and to each of the analog communication modules 74 of the light fixtures 14. Each analog communication module 74 can be configured to facilitate control of the LED lights 72 associated therewith to achieve the lighting intensity requested by the analog control signal. Each of the analog communication modules 74 can be configured to amplify the analog version of the control signal to compensate for any degradation that may occur during transmission of the analog control signal to each of the light fixtures 14.

The digital control signal can be transmitted from the digital communication module 64, to the digital input/output 65, to the digital bus, and to each of the digital communication modules 76 of the light fixtures 14. Each digital communication module 76 can be configured to facilitate control of the LED lights 72 associated therewith to achieve the lighting intensity requested by the digital control signal. Due to the nature of the transmission of the digital control signal along the digital bus and the daisy chained connection between the digital communication modules 76, the digital signals might not require amplification to reach each of the light fixtures 14. In one embodiment, each of the light fixtures 14 can have a unique address (e.g., an IP address). In such an embodiment, the digital control signal can include unique instructions (e.g., packets) for the each of the light fixtures 14 that allows the lighting intensity of the LED lights 72 of each light fixture 14 to be controlled independently.

The analog control signal and the digital control signal can be transmitted to each of the light fixtures 14 simultaneously to provide redundancy for the light fixtures 14. If the transmission of either of the analog control signal or the digital control signal is somehow interrupted (e.g., due to failure of an internal component, external signal interference, or failure of one of the analog communication lines 16, 20 or the digital communication lines 18, 22), the controller 12 can use the other communication line to operate the light fixtures 14, thereby maintaining the overall integrity of the lighting system 10 until the communication system can be repaired. In one embodiment, the digital control signal can be the primary mode for controlling the light fixtures 14. In such an embodiment, when both of the digital control signal and the analog control signal are present at the light fixtures 14, the digital control signal can control the lighting intensity of the LED lights 72. However, if the digital control signal is somehow interrupted for one or more of the light fixtures 14, the analog control signal can then control the lighting intensity of the LED lights 72 that are no longer able to receive the digital control signal.

The analog control signal can be any of a variety of analog signal formats (e.g., 0-10 VDC, 0-20 VDC, 4-20 mA, 0-20 mA) and the digital control signal can be any of a variety of digital signal formats (e.g., RS-485, ModBus, BacNET, CamNET, ASCII) depending upon the configuration of the controller 12. In one embodiment, the digital signal format can facilitate support of up to 2,000 light fixtures 14 with the controller 12.

Still referring to FIG. 4, the CAN communication module 66 can include a digital output 67 that is routed to the CAN communication port 50 and is communicatively coupled with the sensors 24 via the CAN communication bus 26. The CAN communication module 66 can be configured to communicate with each of the sensors 24 using a controller area network (CAN) architecture that facilitates bidirectional communication between the controller 12 and each of the sensors 24 and between the sensors 24 themselves. The CAN communication module 66 can poll each sensor 24 individually and each sensor 24 can respond accordingly (with a response message) to facilitate collection of sensor data and health data from each sensor 24. When each sensor 24 is polled, a light on the sensor 24 can be illuminated. If the CAN communication module 66 detects a problem with the health of one or more of the sensors 24 (e.g., based on the response message from the sensor 24), such as a communication problem or a faulty sensor, the controller 12 can notify a user of the location of the problematic sensor by activating an indicator (e.g., a light or an audible sound) on the problematic sensor, activating an indicator on a surrounding sensor (e.g., intermittently illuminating an indicator on an adjacent sensor to the problematic sensor (e.g., an immediately upstream or downstream sensor)), and/or displaying the unique ID of the problematic sensor on the display screen 32. Each of the sensors 24 can be any environmental sensor that is configured to detect environmental conditions of the lighting system 10 or the surrounding environment, such as, for example, a temperature sensor, a humidity sensor, or a CO2 sensor. In one embodiment, the CAN architecture can allow for up to 256 sensors or other CAN enabled devices to be communicatively coupled with the CAN communication module 66.

Each of the sensors 24 can be powered by the CAN power bus 27 that is electrically coupled with the controller 12 and receives power therefrom. The CAN power bus 27 can be powered by input power received from the power port 52 or from another power source that is coupled with the controller 12. The CAN power bus 27 can be electrically coupled with each of the sensors 24 and can facilitate the delivery CAN rated power (e.g., about 0.5 amps at 5 VDC) from the controller 12 to each of the sensors 24 for powering the sensors 24. The CAN power bus 27 can be electrically isolated from the CAN communication bus 26 such that the sensors 24 are powered directly from the CAN power bus 27 and do not rely on the CAN communication bus 26 for power.

The CAN communication bus 26 and the CAN power bus 27 can be provided within the same cable (not shown) that is routed between the controller 12 and the first one of the light fixtures 14 or that is routed between the light fixtures 14. In one embodiment, the controller 12 can include a CAN internal transformer (not shown) that can convert the input power delivered to the controller 12 into the CAN rated power. It is to be appreciated that the sensors 24 can additionally or alternatively be powered by an external power source that is routed directly to the sensors 24 and thus bypasses the controller 12. It is also to be appreciated that, although sensors 24 are described herein, any of a variety of suitable alternative CAN devices are contemplated, such as, for example, actuators. These alternative CAN devices can be communicatively coupled with, and powered by, the controller 12 in a similar manner as described above for the sensors 24 (i.e., via the CAN communication bus 26 and CAN power bus 27, respectively).

The controller 12 can be configured to test the light fixtures 14 to determine whether any of the light fixtures 14 are faulty and thus need to be replaced or repaired. These tests can be conducted when commissioning the lighting system 10 and/or as part of routine maintenance. In one embodiment, the controller 12 can be configured to conduct an illumination test on the light fixtures 14 that enables a user to visually inspect the LED lights 72 for abnormalities such as failed or dim LED lights. The illumination test can be initiated manually (e.g., via the user interface) or automatically (e.g., as part of a predetermined testing schedule). The controller 12, in response, can transmit a control signal (an analog control signal and/or a digital control signal) to each of the light fixtures 14 that includes instructions for powering the LED lights 72 of all of the light fixtures 14 to a particular lighting intensity (e.g., 50%) and the LED lights 72 can respond accordingly. For the light fixtures 14 that are fully operational (i.e., healthy), their LED lights 72 can be powered at the instructed lighting intensity. For light fixtures 14 that have faulty LED lights 72 (e.g., inoperable, dim, or intermittent), their LED lights 72 can appear different from the fully operational light fixtures which can allow a user to easily identify the faulty light fixtures for repair or replacement when performing a visual inspection. Once the user has completed the visual inspection, the illumination test can be terminated (e.g., via the user interface) which can allow the controller 12 to resume normal operation. In one embodiment, during the illumination test, the controller 12 can vary the lighting intensity of each the light fixtures 14 simultaneously (e.g., between 0% (off) and 50%) to allow the user to inspect the LED lights 72 at different intensities. This can be useful to help determine whether the LED lights 72 might be faulty at certain intensities or when transitioning between intensities that might not otherwise be apparent when simply powering the LED lights 72 at full lighting intensity (e.g., 100%).

The controller 12 can also be configured to conduct a diagnostic test on the light fixtures 14 to determine the health of the light fixtures 14. The light fixtures 14 can be subjected to various different fault conditions that affect the operability of the light fixtures 14 but may not be readily apparent through a visible inspection. These fault conditions can include, a light fixture 14 that is improperly connected properly to the controller 12, a failed or failing digital communication module 76, a failing power supply, or a light fixture 14 that is improperly addressed, for example. The diagnostic test can identify whether any of the light fixtures 14 are experiencing these types of fault conditions (e.g., are faulty) and can notify a user accordingly. Each of the light fixtures 14 can have a unique digital address (e.g., an IP address) that allows the controller 12 to communicate directly with each light fixture 14 in order to identify which of the light fixtures 14 may be experiencing a communication fault condition.

One example of the diagnostic test will now be described. When the diagnostic test is initiated, the controller 12 can assess the health of each light fixture 14 by transmitting a unique digital interrogation signal (e.g., as one or more packets via the digital communication module 64) to each of the light fixtures 14. Each unique digital interrogation signal can facilitate interrogation of the light fixtures 14 to determine whether any fault conditions exist. Each unique digital interrogation signal can include a unique address of one of the light fixtures 14 that facilitates routing of the unique digital signal to the appropriate light fixture 14 for interrogation thereof. Each light fixture 14 can respond to the unique digital interrogation signal from the controller 12 by transmitting a unique digital response signal (e.g., as one or more packets) back to the controller 12 that includes its unique digital address and may also include diagnostic information requested by the controller 12. The controller 12 can detect the responses from those light fixtures 14 by their unique digital response signals and can analyze the signal to identify which light fixtures 14 are healthy and which light fixtures 14 are faulty. In one embodiment, the controller 12 can identify a faulty light fixture as a function of the signal strength of the unique digital response signal. If the signal strength of a particular unique digital response signal is below a threshold level, the controller 12 can identify the light fixture 14 associated with that signal as being faulty. In another embodiment, the controller 12 can identify a faulty light fixture as a function of the presence of the unique digital response signal at the controller 12. If one of the light fixtures 14 does not transmit a unique digital response signal or the unique address in the unique digital response signal is incorrect, the controller 12 can identify the light fixture 14 associated with that signal as being faulty.

For each faulty light fixture identified by the controller 12, the controller 12 can facilitate generation of an alarm on a different light fixture than the faulty light fixture to indicate the location of the faulty light fixture to a user. In one embodiment, the controller 12 can be configured to intermittently illuminate (e.g., flash) the LED lights 72 and/or generate an audible alarm on a light fixture that is immediately adjacent to the faulty light fixture (e.g., an immediately upstream or downstream light fixture) to indicate to a user the location of the faulty light fixture. The controller 12 can additionally or alternatively facilitate generation of an alarm onboard the faulty light fixture. For example, each of the light fixtures 14 can include an onboard indicator, such as an indicator light or an audible alarm, for example. The indicator light can be one of the LED lights 72 or can be provided separate from the LED lights 72 such as along an exterior of the light fixture 14. In such an embodiment, the controller 12 can be configured to activate the onboard indicator on the faulty light fixture or an adjacent light fixture.

It is to be appreciated that the diagnostic test described above can additionally or alternatively used to determine other types of fault conditions for the light fixtures 14. In one embodiment, the controller 12 can be configured to conduct a diagnostic test to determine whether an internal component, such as a driver circuit, a single LED, or an internal sensor of one of the light fixtures 14 has failed. In such an embodiment, the unique digital interrogation signal that is sent to each of the light fixtures 14 can include a request for a health status update for the internal component(s). Each unique digital response signal from the light fixtures 14 can include the health status of the internal component. If the health status indicates that the internal component is faulty, the controller 12 can facilitate generation of an alarm that indicates the location of the light fixture (e.g., 14) that includes the faulty internal component in a similar manner as described above. The controller 12 can be configured to indicate the faulty light, the fault condition and/or the faulty component to a user on the display screen 32.

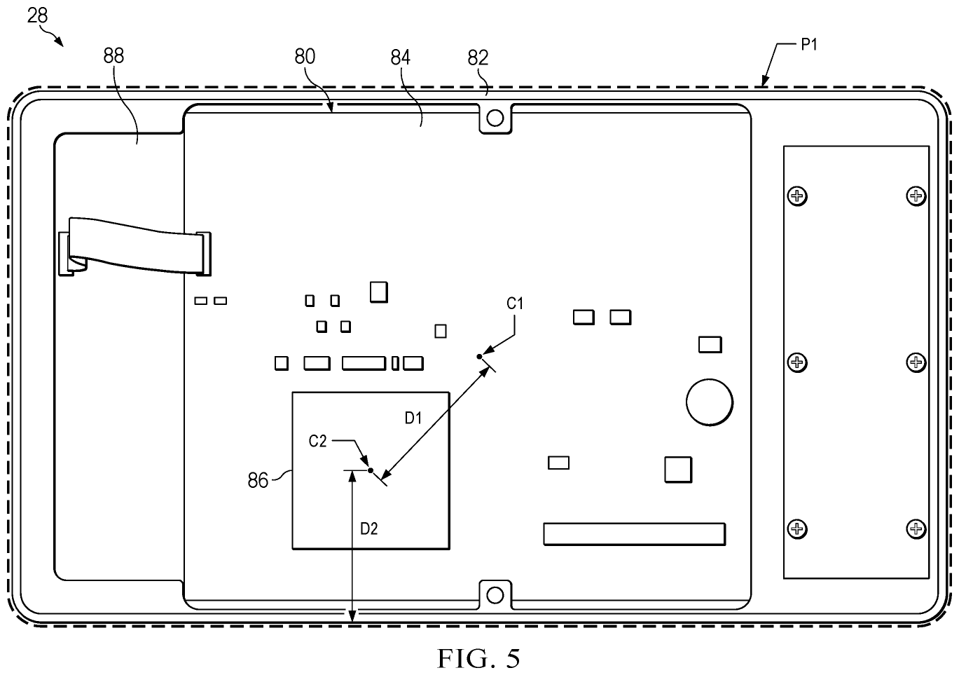

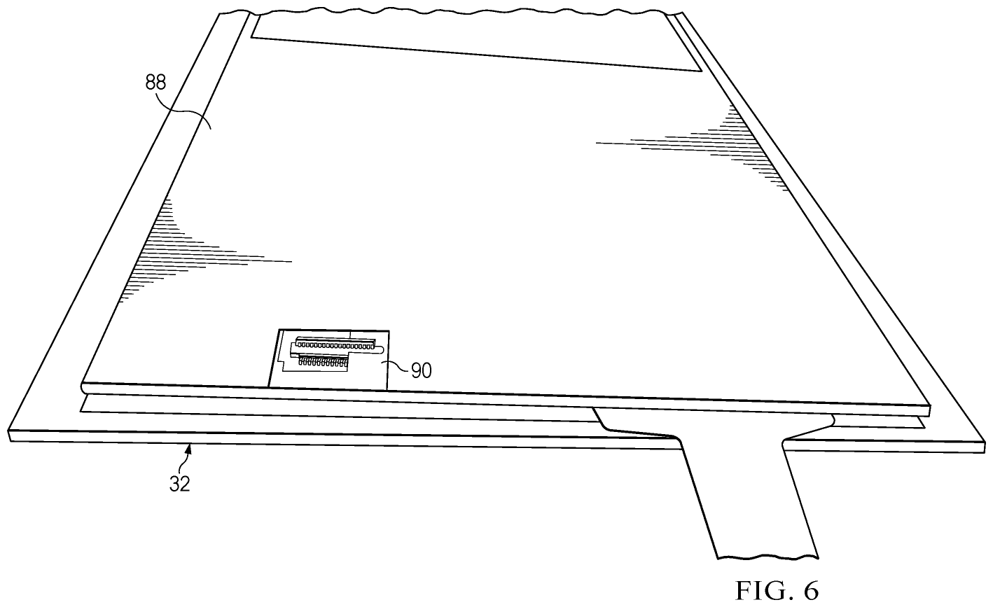

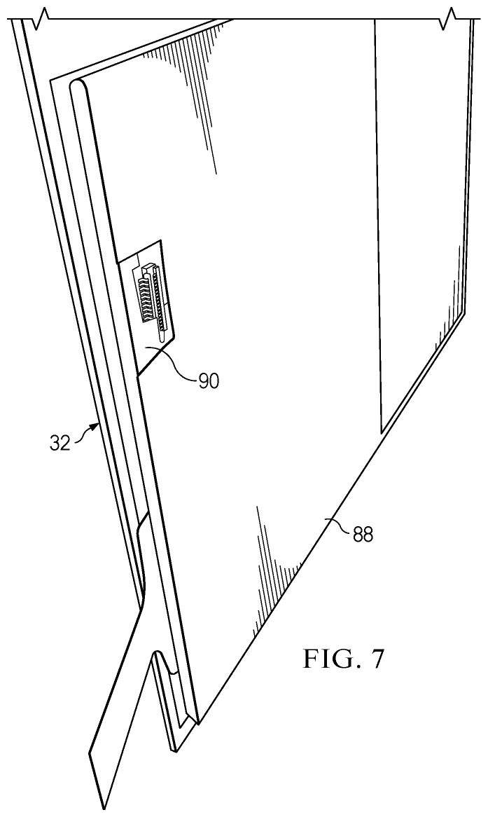

Referring now to FIG. 5, the front panel 28 can include a printed circuit board (PCB) 80 and a bezel 82 to which the display screen 32 (FIG. 1) and the PCB 80 are mounted (i.e., releasably coupled). The PCB 80 can include a substrate 84 and a micro controller unit (MCU) 86 mounted to the substrate 84. Referring now to FIGS. 5-7, the front panel 28 can include a thermally conductive substrate 88 that can be secured to a rear surface 90 (FIGS. 6 and 7) of the display screen 32 and sandwiched between the display screen 32 and the substrate 84 of the PCB 80. The thermally conductive substrate 88 can be thermally coupled with the MCU 86 and the bezel 82 and can be configured to dissipate heat generated by the MCU 86 away from the MCU 86 and to the bezel 82. The thermally conductive substrate 88 can be thermally coupled with the MCU 86 via thermally conductive vias (not shown) that are routed through the substrate 84 and contain thermally conductive material (e.g., copper) that is coupled with the MCU 86 and the thermally conductive substrate 88. In one embodiment, the thermally conductive substrate 88 can be formed of thermally conductive thin-film acrylic. It is to be appreciated, however, that the thermally conductive substrate 88 can be formed of any of a variety of suitable alternative thermally conductive thin-film materials.

The bezel 82 can be formed of a thermally conductive material (e.g., carbon fiber reinforced thermoplastic impregnated with metal fibers) and coupled with the rear housing 30 (FIGS. 1 and 2) that is also thermally conductive, as described above. As such, heat generated from the MCU 86 that is dissipated to the bezel 82 (via the thermally conductive substrate 88) can be further dissipated to the rear housing 30 to facilitate cooling of the MCU 86 via the rear housing 30. The rear housing 30 can accordingly serve as a heat sink for the MCU 86. In one embodiment, the rear housing 30 can facilitate effective cooling of the MCU 86 without utilizing ambient air cooling vents that allow for the introduction of external cooling air into the rear housing 30 (typically found in conventional horticultural controllers). In such an embodiment, the rear housing 30 can deter water from inadvertently being introduced inside of the rear housing 30 (e.g., from a sprinkler).

Referring again to FIG. 5, the substrate 84 can define an outer perimeter P1 and a physical center C1. The MCU 86 can be provided at a physical location on the substrate 84 that is more proximate to the outer perimeter P1 than the physical center C1. In one embodiment, as illustrated in FIG. 5, the MCU 86 can define a physical center C2 that is spaced from the physical center C1 of the substrate 84 by a distance D1 and is spaced from the outer perimeter P1 by a distance D2. The MCU 86 can be more proximate the outer perimeter PI than the physical center P1 such that the distance D2 is less than the distance D1.

When the MCU 86 radiates heat, the amount of heat that is dissipated through a portion of the thermally conductive substrate 88 to the bezel 82 can be a function of the distance of the MCU 86 from the bezel 82. In other words, the more proximate a portion of the MCU 86 is to the bezel 82, the more heat that can be dissipated therebetween. Since the MCU 86 is positioned more proximate to the outer perimeter P1 than the physical center C1, more heat can be dissipated from the MCU 86 to the bezel 82 at the areas where the MCU 86 is closer to the outer perimeter Pl (e.g., along the distance D2) than the areas where the MCU 86 is further away from the bezel 82 (e.g., in the direction D1 of the physical center C2). As a result, less heat can be dissipated along the display screen 32 which can allow the display screen 32 to be cooler to the touch, to operate at lower internal temperatures, and to be less susceptible to overheating than conventional horticultural controllers.

Even though much of the heat from the MCU 86 is able to be dissipated through the thermally conductive substrate 88, some of the heat can remain concentrated at the MCU 86. Because the MCU 86 is located at a position that is spaced away from the physical center C1 of the substrate 84, the display screen 32 can be less susceptible to hot spots and overheating that is typically associated with conventional horticultural controllers that have MCUs that are more centrally located on a substrate.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended that the scope be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

1. A controller for a lighting system, the controller comprising:
a digital communication module configured to transmit a digital control signal to a light fixture that includes instructions for controlling a lighting parameter of the light fixture;
an analog communication module configured to transmit an analog control signal to the light fixture simultaneously with the digital control signal and that includes instructions for controlling the lighting parameter of the light fixture that are substantially the same as the instructions from the digital control signal; and
a CAN communication module configured to facilitate bidirectional communication with an environmental sensor via a controller area network architecture.

2. The controller of claim 1 wherein the lighting parameter comprises a lighting intensity of the light fixture.

3. The controller of claim 1 wherein the analog control signal comprises a 0-10 VDC signal and the digital control signal comprises an RS-485 signal.

4. The controller of claim 1 further comprising:
a front panel comprising a display screen configured to display a user interface for the light fixture; and
a rear housing coupled with the front panel.

5-8. (canceled).

9. The controller of claim 8 wherein the rear housing is formed of a carbon fiber reinforced thermoplastic that is impregnated with metal.

10. A lighting system for an indoor grow facility, the lighting system comprising:
a lighting controller comprising:
a main digital communication module configured to transmit a digital control signal;
a main analog communication module configured to transmit an analog control signal; and
a CAN communication module;
a light fixture comprising:
a plurality of LED lights;
an LED driver circuit electrically coupled with the plurality of LED lights;
an LED controller in signal communication with the LED driver circuit and configured to transmit a driver signal to the LED driver circuit for controlling operation of the plurality of LED lights;
an LED digital communication module in signal communication with the main digital communication module for receiving the digital control signal; and
an LED analog communication module in signal communication with the main analog communication module for receiving the analog control signal; and
a sensor in signal communication with the CAN communication module, wherein:
the main controller transmits the digital control signal and the analog control signal simultaneously to the LED digital communication module and the LED communication module, respectively;
the digital control signal includes instructions for controlling a lighting parameter of the light fixture;
the analog control signal includes instructions for controlling the lighting parameter of the light fixture that are substantially the same as the instructions from the digital control signal; and
the CAN communication module facilitates bidirectional communication with the sensor via a controller area network architecture to collect sensor data therefrom.

11. The lighting system of claim 10 wherein the sensor is external to the light fixture.

12. The lighting system of claim 11 wherein the sensor comprises one or more of a temperature sensor, a humidity sensor, and a CO2 sensor.

13. The lighting system of claim 10 wherein the lighting parameter comprises a lighting intensity of the light fixture.

14-19. (canceled).

20. A method for testing a plurality of light fixtures of a lighting system, the lighting system comprising a controller communicatively coupled with the plurality of light fixtures, the method comprising:
interrogating, by the controller, each light fixture of the plurality of light fixtures;
detecting, by the controller, responses from the plurality of light fixtures to the interrogation;
identifying, by the controller, a faulty light fixture from the responses of the plurality of light fixtures; and
generating an alarm, by the controller, on a different light fixture of the plurality of light fixtures than the faulty light fixture.

21. The method of claim 20 wherein interrogating each light fixture further comprises routing, by the controller, a unique interrogation signal to each light fixture of the plurality of light fixtures.

22. The method of claim 21 wherein:
each light fixture of the plurality of light fixtures comprises a unique address; and
each unique interrogation signal is routed to one of the light fixtures of the plurality of light fixtures based upon the unique address.

23. The method of claim 20 wherein detecting responses from the plurality of light fixtures comprises detecting unique response signals from the plurality of light fixtures.

24. The method of claim 23 wherein:
each light fixture of the plurality of light fixtures includes; and
the unique response signal from each light fixture includes a unique address that identifies the light fixture.

25. The method of claim 23 wherein:
detecting responses from the plurality of light fixtures comprises detecting signal strengths of the unique response signals; and
identifying the faulty light fixture is based upon the signal strengths of the unique response signals.

26. The method of claim 25 identifying the faulty light fixture comprises identifying which unique response signal has a signal strength below a predefined threshold.

27. The method of claim 23 wherein:
detecting responses from the plurality of light fixtures comprises detecting a presence of the unique response signals at the controller; and
identifying the faulty light fixture is based upon the presence of the unique response signals at the controller.

28. The method of claim 27 wherein identifying the faulty light fixture comprises identifying which unique response signal is not present at the controller.

29. The method of claim 20 wherein the different light fixture is adjacent the faulty light fixture.

30. The method of claim 29 wherein the different light fixture is immediately adjacent the faulty light fixture.
